(19) United States
(12) Patent Application Publication
(10) Pub. No.: US 2003/0160813 A1
(43) Pub. Date: Aug. 28, 2003

(54) Method and apparatus for a dynamically-controlled remote presentation system

(76) Inventor: Narayan D. Raju, Milpitas, CA (US)

Correspondence Address: ROSENTHAL & OSHA L.L.P. / SUN, 1221 MCKINNEY, SUITE 2800, HOUSTON, TX, 77010, US

(21) Appl. No.: 10/082,557

(22) Filed: Feb. 25, 2002

(51) Int. Cl. G09G 5/00

(52) U.S. Cl. 345/730; 345/732

(57) ABSTRACT

A remote presentation system having a client operatively connected to a server operatively connected to a remote display device, including a graphical user interface located on the client providing functionality to control the remote presentation system, a client logic located on the client providing an interface between the graphical user interface and the server, a presentation application located on the server for executing and displaying a presentation, a server logic located on the server providing an interface between the presentation application and the client, and a presentation plug-in located on the remote display device providing an interface between the remote display device and the server.

### CROSS-REFERENCE TO RELATED APPLICATIONS

This application claims benefit of U.S. non-Provisional application Ser. No. 10/020,017 filed on Dec. 7, 2001, and entitled “Method and Apparatus for a Networked Projection System”, in the name of Narayan D. Raju.

### BACKGROUND OF INVENTION

With the emergence of a global marketplace, companies have become larger and more geographically dispersed. This change has increased the need for communication between all levels within a company as well as with other companies and consumers. To meet this demand the Internet has emerged as a new medium for business communications.

One specific aspect of business communications that has moved to the forefront is web-based multimedia presentations. Companies such as WebEx Communications, Inc. (San Jose, Calif.) and Placeware, Inc. (Mountain View, Calif.) provide web-based solutions for companies.

FIG. 1 illustrates a typical network system for web-based multimedia presentations. The network system includes a presenter computer (10), a viewing computer (12), and a conference web-server (14). The presenter computer (10) includes a media storage (16), an application (18), a presenter conference plug-in (20), and a presenting computer web browser (22). The viewing computer includes a viewer conference plug-in (24) and a viewing computer web browser (26).

Typically, a presenter using the presenter computer (10) starts a session by connecting to a conference web-server (14) via the presenter computer web browser (22). The conference web-server (14) is typically located at a different location than the presenter computer (10). Further, the conference web-server (14) is typically operated by a web-based presentation company such as WebEx Communications, and is typically running proprietary software and protocols e.g., T.120 protocol. The presenter than proceeds to start an application (18) e.g., PowerPoint® using files stored in the media storage (16) e.g., local hard drive. The presenter conference plug-in (20) captures all content on the screen and forwards it to the conference web-server (14). Individuals that wish to view the presentation herein referred to as “Viewers,” logon to the conference web-server (14) and connect to the appropriate presentation typically using a presentation identification code. The viewers, through the viewing computer web browser (26) via the viewer conference plug-in (24), see the same screen view as the presenter.

FIG. 2 illustrates typical screen views of the viewing computer and the presenter computer. The presenter computer web browser (22) located on the presenter computer (10) is presenting an image (28). The viewing computer web browser (26) located on the viewing computer (12) presents the same image (28). Further, if the presenter loads different applications on the presenting computer (28), or changes text on the screen, etc., the viewer will see all changes on the viewing computer.

### SUMMARY OF INVENTION

In general in one aspect, the invention relates to a remote presentation system having a client operatively connected to a server operatively connected to a remote display device, comprising a graphical user interface located on the client providing functionality to control the remote presentation system, a client logic located on the client providing an interface between the graphical user interface and the server, a presentation application located on the server for executing and displaying a presentation, a server logic located on the server providing an interface between the presentation application and the client, and a presentation plug-in located on the remote display device providing an interface between the remote display device and the server.

In general, in one aspect, the invention relates to a graphical user interface for a remote projection system, comprising a first portion of the graphical user interface, a second portion of the graphical user interface, an output window located in the first portion displaying a current slide in a presentation, a control panel located in the first portion, and a plurality of slides located in the second portion.

In general, in one aspect, the invention relates to a method of using a remote presentation system in a distributed environment, comprising logging onto a server, initializing a graphical user interface using the server, loading a presentation file onto the server, selecting a presentation application using logic of the server, opening the presentation file using the selected presentation application into a presentation, capturing the presentation as a plurality of thumbnails, and forwarding the plurality of thumbnails to the graphical user interface located on the client.

In general, in one aspect, the invention relates to a method of using a remote presentation system in a distributed environment, comprising logging onto a server, initializing a graphical user interface using the server, loading a presentation file onto the server, selecting a presentation application using logic of the server, opening the presentation file using the selected presentation application into a presentation, capturing the presentation as a plurality of thumbnails, forwarding the plurality of thumbnails to the graphical user interface located on the client, selecting a one of the plurality of thumbnails, moving the one of the plurality of thumbnails to a new location within the presentation, and re-assembling the presentation to create a modified presentation using the new location of the one of the plurality of thumbnails.

In general, in one aspect, the invention relates to a method of using a remote presentation system in a distributed environment, comprising logging onto a server, initializing a graphical user interface using the server, loading a presentation file onto the server, selecting a presentation application using logic of the server, opening the presentation file using the selected presentation application into a presentation, capturing the presentation as a plurality of thumbnails, forwarding the plurality of thumbnails to the graphical user interface located on the client, selecting a one of the plurality of thumbnails, modifying a thumbnail property of the one of the plurality of thumbnails creating a modified thumbnail, and re-assembling the presentation to create a modified presentation using the modified thumbnail.

In general, in one aspect, the invention relates to an apparatus for using a remote presentation system in a distributed environment, comprising means for logging onto a server, means for initializing a graphical user interface using the server, means for loading a presentation file onto the server, means for selecting a presentation application using logic of the server, means for opening the presentation file using the selected presentation application into a presentation, means for capturing the presentation as a plurality of thumbnails, and means for forwarding the plurality of thumbnails to the graphical user interface located on the client.

In general, in one aspect, the invention relates to an apparatus for using a remote presentation system in a distributed environment, comprising means for logging onto a server, means for initializing a graphical user interface using the server, means for loading a presentation file onto the server, means for selecting a presentation application using logic of the server, means for opening the presentation file using the selected presentation application into a presentation, means for capturing the presentation as a plurality of thumbnails, means for forwarding the plurality of thumbnails to the graphical user interface located on the client, means for selecting a one of the plurality of thumbnails, means for moving the one of the plurality of thumbnails to a new location within the presentation, and means for re-assembling the presentation to create a modified presentation using the new location of the one of the plurality of thumbnails.

In general, in one aspect, the invention relates to an apparatus for using a remote presentation system in a distributed environment, comprising means for logging onto a server, means for initializing a graphical user interface using the server, means for loading a presentation file onto the server, means for selecting a presentation application using logic of the server, means for opening the presentation file using the selected presentation application into a presentation, means for capturing the presentation as a plurality of thumbnails, means for forwarding the plurality of thumbnails to the graphical user interface located on the client, means for selecting a one of the plurality of thumbnails, means for modifying a thumbnail property of the one of the plurality of thumbnails creating a modified thumbnail, and means for re-assembling the presentation to create a modified presentation using the modified thumbnail.

Other aspects and advantages of the invention will be apparent from the following description and the appended claims.

### BRIEF DESCRIPTION OF DRAWINGS

FIG. 1 illustrates a typical network system for web-based multimedia presentations.

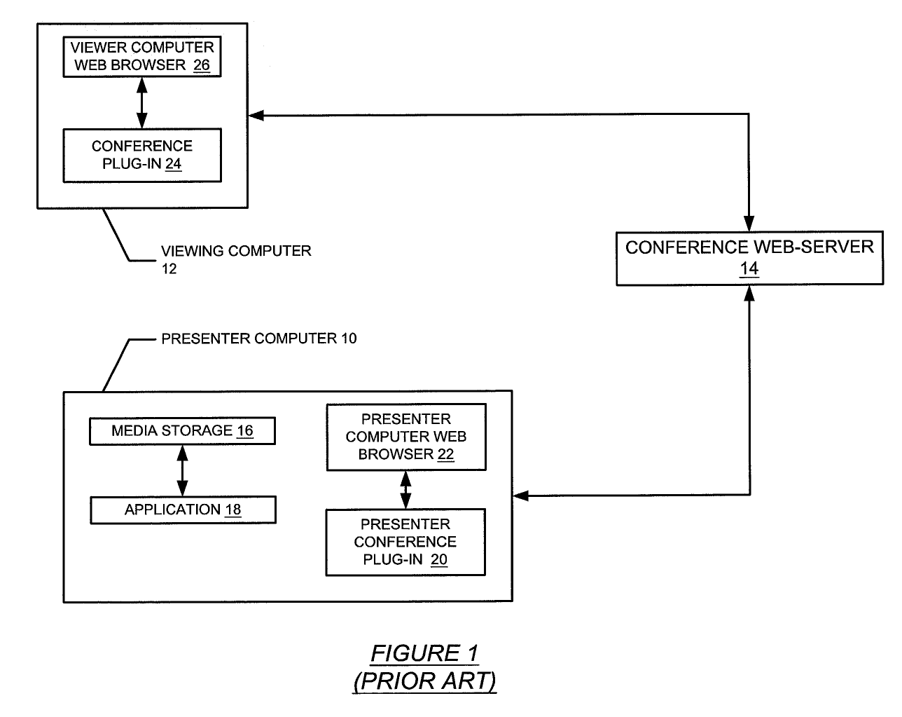

FIG. 2 illustrates typical screen views of the viewing computer and the presenter computer.

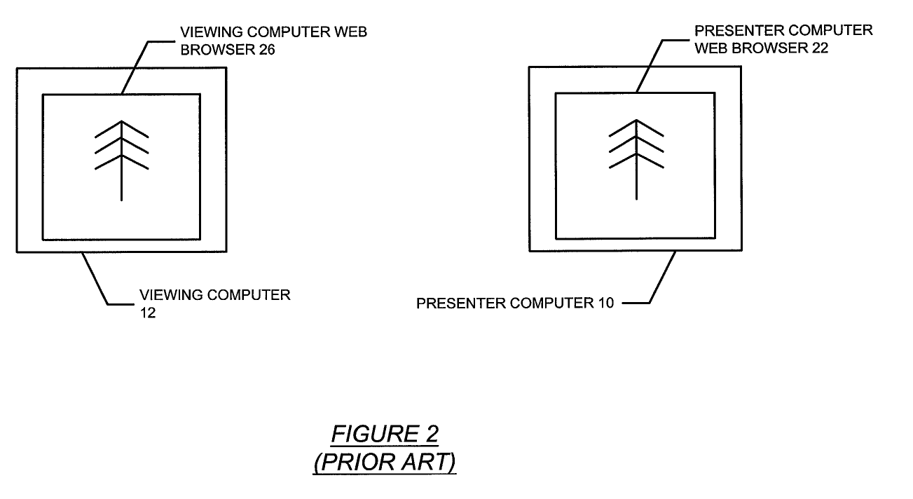

FIG. 3 illustrates a network system in accordance with one or more embodiments of the present invention.

FIG. 4 illustrates a Graphical User Interface in accordance with one or more embodiments of the present invention.

FIG. 5 illustrates a network system in accordance with one or more embodiments of the present invention.

FIG. 6 illustrates typical screen views in accordance with one or more embodiments of the present invention illustrated in FIG. 5.

FIG. 7 illustrates, in flowchart form, the typical steps involved in starting a presentation in accordance with one or more embodiments of the present invention

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to a remote presentation system. Further, the present invention relates to a graphical user interface for the presentation system. Further, the present invention relates to a method for dynamically modifying a running presentation.

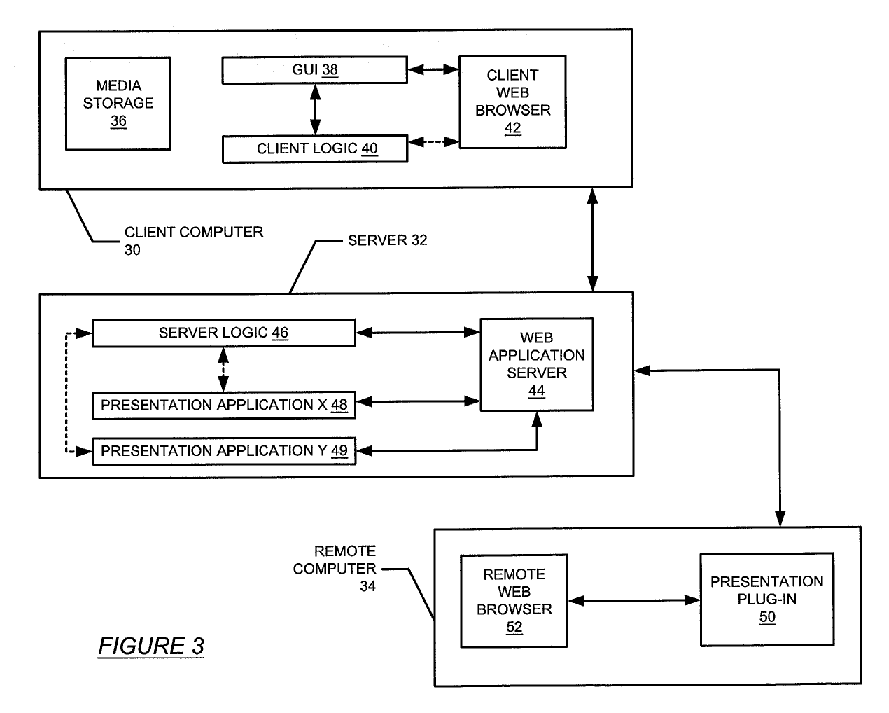

FIG. 3 illustrates a network system in accordance with one or more embodiments of the present invention. The network system includes a client computer (30), a server (32) and a remote computer (34). The client computer (30) contains a media storage (36), a Graphical User Interface (GUI) (38), a client logic (40), and a client web browser (42). The media storage (36) is typically a local hard drive where presentation content, e.g., StarOffice™ Impress file, is stored. In another embodiment of the present invention, the media storage is located on a separate computer such as a file server, which may be remotely accessed by the client computer (30). The GUI (38) provides the user of the client computer (30) with a visual computer environment. Further, the GUI (30) provides an interface that allows the user of the client computer to control the remote presentation system. The client logic (40) contains the client-side program logic for the GUI (38). For example, when a user of the client computer (30) clicks on part of the GUI (38) the client logic (40) interprets the command and carries out the corresponding action. The client web browser (42) is software that allows a user to view HyperText Mark-up Language (HTML) documents and access files and software related to those documents. Further, the web browser (42) is also capable of such functions as downloading and transferring files, providing access to newsgroups, displaying graphics embedded in a document, playing audio and video files associated with the document, and executing small programs, e.g., Java™ applets or Active® controls included by programmers in the documents. An example of a web browser (42) is Netscape® Navigator. In one or more embodiments of the present invention, the GUI (38) is integrated into the web browser (42).

The server (32) contains a web application server (44), a server logic (46), and a presentation application (48). The web application server (44) uses HyperText Transfer Protocol (HTTP) to serve up HTML documents and any associated files and scripts requested by the client computer (30) running the client web browser (42). The server logic (46) contains the server-side program logic for the GUI (38). For example, when the client logic (40) receives a command from the GUI (38), the client logic (40) interprets the command and carries out the corresponding action. This typically involves sending a request to the server logic (46). The server logic (46) interprets the request and applies the appropriate program logic to generate a valid response e.g., retrieve information from a presentation application (48) located on the server (32) and forward the retrieved information back to the client computer (30). The presentation application (48) is typically proprietary software such as StarOffice™ Impress, Microsoft PowerPoint®, etc. that is used to generate/create presentations. The server (32) may contain more than one presentation application (49). In one or more embodiments of the present invention the server logic (46) is integrated with the web application server.

The remote computer (34) contains a presentation plug-in (50) and a remote web browser (52). The remote web browser (52) has be same functionality as the client web browser (42). The presentation plug-in (50) allows a viewer of the remote computer to view the presentation that is currently being presented by a presenter on the client computer (30). The presentation plug-in (50) typically interacts with the server (32) to view the presentation. The presentation plug-in (50) is typically a software program that “plugs into” a larger application to provide additional functionality. For example, a presentation plug-in (50) may plug into Netscape® Navigator. The presentation plug-in (50) permits Netscape® Navigator to access and execute embedded files in HTML documents that are in formats the web-browser normally would not recognize, such as many animation, video, audio files, etc. The presentation plug-ins (50) are typically developed by software companies, which have proprietary software in which the embedded files are created. For example, a typical presentation plug-in is a WebEx Client developed by WebEx Communications, Inc. While FIG. 3 illustrates only a single remote computer, those skilled in the art will appreciate that numerous remote computers may be connected to the server.

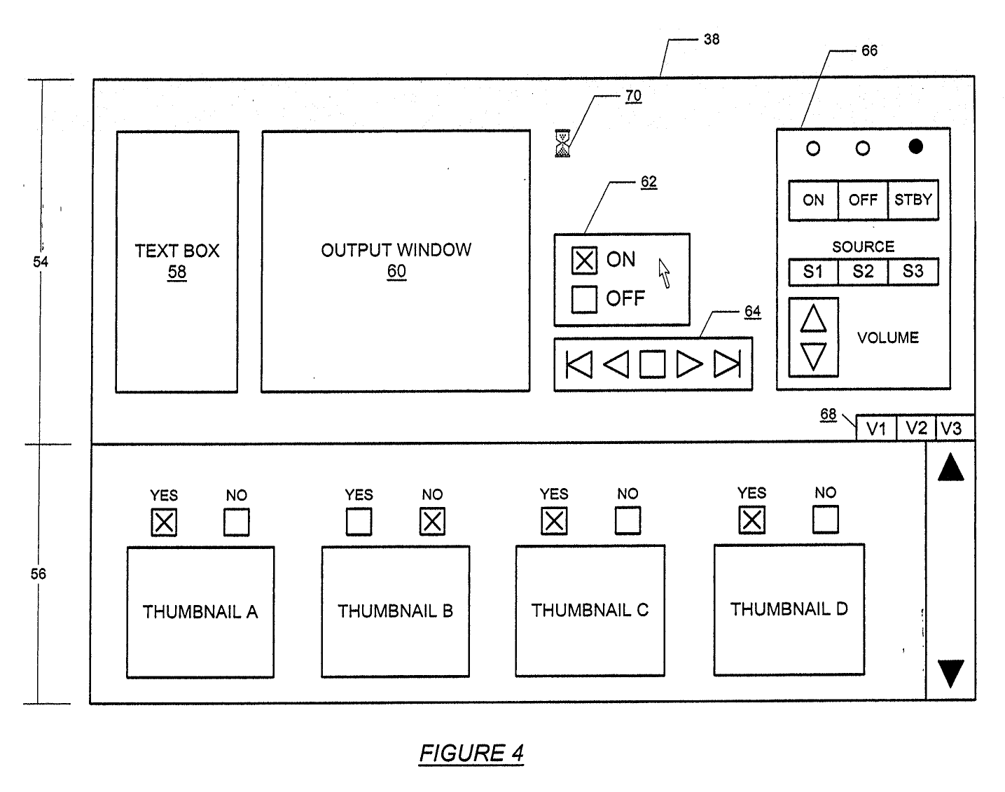

FIG. 4 illustrates a GUI in accordance with one or more embodiments of the present invention. The GUI (38) contains a top frame (54) and a bottom frame (56). The top frame (54) contains the GUI (38) controls and the bottom frame (56) contains the presentation content. The top frame (56) includes a text box (58), an output window (60), a pointer control (62), a slide control (64), a source control (66), a view control (68), and a status indicator (70). The text box (58) typically contains a presenter's notes for a particular slide being shown in the output window (60). The output window (60) contains the content that is being seen on a remote computer e.g., current slide in the presentation. The pointer control (62) allows the presenter to turn the pointer ON/OFF. When the pointer control (62) is toggled ON, if the pointer is moved to the portion of the screen where the output window (60) is located then the pointer movements are seen by the remote computer. In contrast, if the pointer control (62) is toggled OFF, if the pointer is moved to the portion of the screen where the output window (60) is located then the pointer movements are not seen the remote computer. This allows the presenter to use the pointer when making the presentation if desired or to have it turned OFF such that the remote computers during the presentation do not see the pointer. The slide control (64) allows the user to forward through the presentation slides, reverse through the presentation slides, stop the presentation at a particular slide, or go directly to the beginning or end of the presentation.

The source control (66) allows the presenter to control remote input and output sources such as a Video Cassette Recorder (VCR), a Compact Disc (CD) player, a networked projector, etc. Additionally, the source controller (66) may contain controls to allow the presenter to turn a particular source ON/OFF or place the source in a Standby (STBY) mode. Further, the source controller (66) may contain controls to control the audio levels of a particular source.

The view controller (68) allows the presenter to control the view of the bottom frame (56). For example, one view of the bottom frame (56) may present the presentation slides as thumbnails without the presenter' notes, and another view may show the presentation slides with the presenters notes on the side. Finally, the status indicator (70) indicates if the content in the output window is being sent to the remote computer (34).

The bottom frame (56) of the GUI (38) contains the presentation content. For each slide in the presentation, denoted as “thumbnails” in FIG. 4, there is an option to turn the slide ON or OFF. If the slide is turned ON then when the presenter uses the slide control (64), that slide is shown in the output window (60). For example, FIG. 4 illustrates four thumbnails (THUMBNAIL_A, THUMBNAIL_B, THUMBNAIL_C, and THUMBNAIL_D). THUMBNAIL_A, THUMBNAIL_C, and THUMBNAIL_D are ON, and THUMBNAIL_B is OFF. When the presenter uses the slide control (64) to advance through the thumbnails (starting at THUMBNAIL_A), only thumbnails A, C and D are shown in the output screen.

In another embodiment of the present invention, the presenter may turn the thumbnails ON/OFF while advancing through the slides. For example, the presentation may currently be on THUMBNAIL_C, and the presenter may decide that the she does not want to show THUMBNAIL_D any more. Thus, she may turn THUMBNAIL_D OFF before using the slide control (64) to advance the presentation to the next thumbnail that is ON.

In one or more embodiments of the present invention, the thumbnails may be rearranged within the bottom frame (56) of the GUI (38) by highlighting a particular thumbnail and dragging it to a new position within the presentation. For example, when the presenter initially created the presentation, she wanted THUMBNAIL_C to proceed THUMBNAIL_D. However, as she is giving the presentation she decides that she would like THUMBNAIL_C to be shown after THUMBNAIL_D, thus she “drags” THUMBNAIL_C behind THUMBNAIL_D. This results in the thumbnails and all associated content, e.g., presenter's notes, etc., being rearranged.

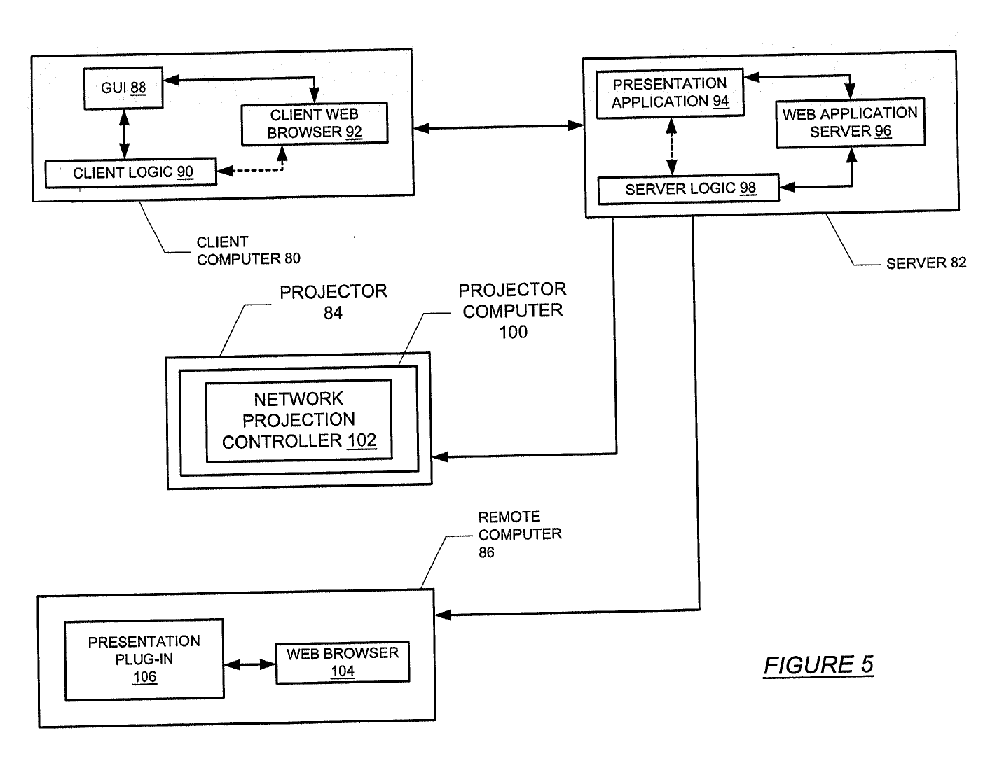

FIG. 5 illustrates a network system in accordance with one or more embodiments of the present invention. The network system includes a client computer (80), a server (82), a projector (84), and a remote computer (86). The client computer (80) contains a GUI (88), a client logic (90), and a client web browser (92). The server (82) contains a presentation application (94), a web application server (96), and a server logic (98). The projector (84) contains a projector computer (100) and a networked projection controller (102). The network projection system operates in a manner described in U.S. patent application Ser. No. 10/020,017 entitled “Method and Apparatus for a Networked Projection System”, filed Dec. 7, 2001 in the name of Narayan D. Raju. The remote computer (86) contains a remote web browser (104) and a presentation plug-in (106).

Referring to FIG. 5, consider the following scenario. A first company, Company X, has two campuses: Campus A and Campus B. Campus A is the head office for Company X. A second company, Company Y, wishes to sell a product to Company X. Company X and Company Y are in different cities. Using the present invention, a vice president of marketing for Company Y can create a presentation on a client computer (80). The vice president of marketing can then log onto the server (82), which is located at Company Y's office. The vice president of marketing may then load the presentation via the GUI (88). At the same time the board of directors for Company X are sitting in a conference room with a networked projector (84) at Campus A. Further, a senior technical analyst for company A is sitting at a remote computer (86) located at campus B. The networked projector (84) and the remote computer (86) can then log onto the server (82) and view the presentation. Since the server (82) may be running multiple presentations simultaneously, when the remote computer (86) and the networked projector (84) log onto the server (82) they may be prompted to enter a presentation number. The presentation number corresponds to the presentation that they wish to see or were invited to see. The presentation number may be generated by the server (82) in conjunction with the client computer (80) and is conveyed to the viewing parties', e.g., board of directors, senior technical analyst, etc., via phone, e-mail, etc., prior to the presentation. The vice president of marketing then proceeds to give the presentation.

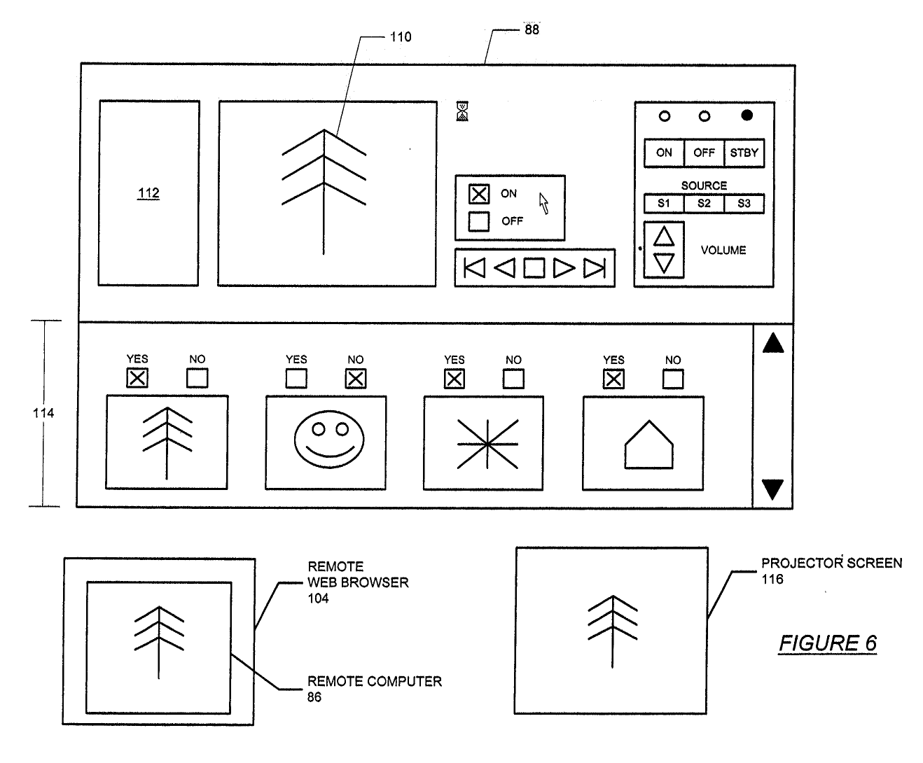

FIG. 6 illustrates typical screen views in accordance with one or more embodiments of the present invention illustrated in FIG. 5. A GUI (88), running on the client computer (80), shows a presenter's screen view. An output window (110) shows the current slide being shown in the presentation. A textbox (112) contains the comments for the current slide. A bottom frame (114) contains all the slides in the presentation. Simultaneously, a remote web browser (104) running on a remote computer (86) contains the content of the output window (110). While the content shown in the output window (110) is reduced in size on the GUI (88), the content fills the entire remote web browser (104) window. Similarly, the content viewed on a projector screen (116) is only the content shown in the output window (110) on the GUI (88). Further, the content fills the entire projection screen (116).

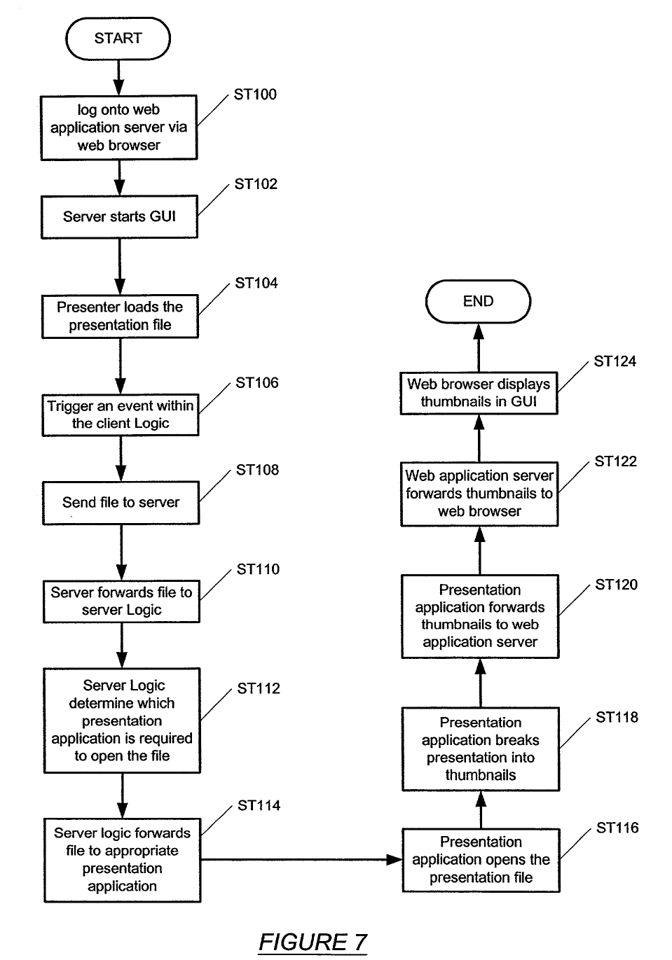

FIG. 7 illustrates, in flowchart form, the typical steps involved in starting a presentation in accordance with one or more embodiments of the present invention. A presenter logs onto a server (82) via a client web browser (92) (Step 100). Typically, this step involves authenticating the presenter based on a company's authentication procedures. The server (82) starts the GUI (88) on the client computer (80) (Step 102). The presenter then proceeds to upload the presentation file (Step 104). This triggers an event within a client logic (90) (Step 106), resulting in sending the presentation file to the server (82) (Step 108). The server (82) forwards the file to a server logic (98) (Step 110). The server logic (98) determines which presentation application (94) to forward the file to (Step 112). The server (82) forwards the file to the appropriate presentation application (94) (Step 114). The presentation application (94) opens the presentation file (Step 116). The presentation application (94) breaks the presentation into thumbnails (Step 118). The presentation application (94) forwards thumbnails to web application server (96) (Step 120). The web application server (96) forwards thumbnails to the client web browser (92) (Step 122). The web browser then displays the thumbnails in the GUI (88) (Step 124).

After the presentation has been started, the presenter may select a thumbnail and move it to the desired location. This selection triggers an event in the client logic (90), resulting in sending the changes to the presentation application (94) to re-assemble the presentation. This process may occur numerous times for a given presentation and within a given presentation. Further, this process may occur while the presentation is occurring. Additionally, slide properties e.g., transition effects, timing etc., may also be modified by the process described above.

For example, a presenter of a the presentation may be partially completed with the presentation when she realizes that she would like to show a slide from the beginning of the presentation again. Thus, she selects the desired thumbnail and moves it (via drag and drop functionality with in the GUI) to the desired location. This selection triggers an event in the client logic resulting in re-sending the presentation application and re-assembling the presentation. The entire process occurs in a manner that is transparent to the individuals viewing the presentation.

Embodiments present invention may have one or more of the following advantages. In some embodiments, the present invention allows a presenter to dynamically change a presentation while the presentation is in progress. Further, in some embodiments, the present invention allows the presenter to dynamically change the presentation in a manner that is transparent to the viewer. Further, in some embodiments, the present invention allows the presenter to control a presentation on a remote computer using a graphical user interface integrated into a web browser.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A remote presentation system having a client operatively connected to a server operatively connected to a remote display device, comprising:
a graphical user interface located on the client providing functionality to control the remote presentation system;
a client logic located on the client providing an interface between the graphical user interface and the server;
a presentation application located on the server for executing and displaying a presentation;
a server logic located on the server providing an interface between the presentation application and the client, and
a presentation plug-in located on the remote display device providing an interface between the remote display device and the server.

2. The system of claim 1, wherein the graphical user interface is integrated within a web browser.

3. The method of claim 1, wherein the server logic is integrated within a web application server.

4. The method of claim 1, wherein the client logic is running within a web browser.

5. The system of claim 1, wherein the graphical user interface comprises logic for dynamically modifying the presentation.

6. The system of claim 1, wherein the server logic comprises logic for obtaining the presentation as a series of thumbnails.

7. A graphical user interface for a remote projection system, comprising:
a first portion of the graphical user interface;
a second portion of the graphical user interface;
an output window located in the first portion displaying a current slide in a presentation;
a control panel located in the first portion; and
a plurality of slides located in the second portion.

8. The graphical user interface of claim 7, wherein the first portion, comprises:
a text box displaying notes related to the current slide displayed in the output window.

9. The graphical user interface of claim 7, wherein the control panel comprises:
a pointer control for controlling a pointer operation in the output window;
a slide control for controlling the current slide displayed in the output window;
a view control for controlling the current view of the second portion; and
a source control for controlling input and output sources operatively connected to a server.

10. The graphical user interface of claim 9, wherein the source control comprises:
a volume control for controlling volume of a selected source; and
a source control for controlling mode of selected source.

11. The graphical user interface of claim 7, wherein the second portion, comprises:
a toggle for each slide controlling a state of the slide.

12. The graphical user interface of claim 11, wherein the state is active.

13. The graphical user interface of claim 11, wherein the state in inactive.

14. The graphical user interface of claim 7, wherein the second portion, comprises:
a client logic integrated with the graphical user interface for providing drag and drop functionality.

15. A method of using a remote presentation system in a distributed environment, comprising:
logging onto a server;
initializing a graphical user interface using the server;
loading a presentation file onto the server;
selecting a presentation application using logic of the server;
opening the presentation file using the selected presentation application into a presentation;
capturing the presentation as a plurality of thumbnails; and
forwarding the plurality of thumbnails to the graphical user interface located on the client.

16. The method of claim 15, further comprising:
selecting a one of the plurality of thumbnails;
moving the one of the plurality of thumbnails to a new location within the presentation; and
re-assembling the presentation to create a modified presentation using the new location of the one of the plurality of thumbnails.

17. The method of claim 15, further comprising:
selecting a one of the plurality of thumbnails;
modifying a thumbnail property of the one of the plurality of thumbnails creating a modified thumbnail; and
re-assembling the presentation to create a modified presentation using the modified thumbnail.

18. The method of claim 15, wherein the logic of the server is integrated into a web application server.

19. The method of claim 15, wherein the graphical user interface is integrated into a web browser.

20. The method of claim 18, wherein the graphical user interface includes logic for dynamically modifying a presentation.

21. The method of claim 18, wherein the logic of the server includes logic for obtaining a presentation as a series of thumbnails.

22. A method of using a remote presentation system in a distributed environment, comprising:
logging onto a server;
initializing a graphical user interface using the server;
loading a presentation file onto the server;
selecting a presentation application using logic of the server;
opening the presentation file using the selected presentation application into a presentation;
capturing the presentation as a plurality of thumbnails;
forwarding the plurality of thumbnails to the graphical user interface located on the client;
selecting a one of the plurality of thumbnails;
moving the one of the plurality of thumbnails to a new location within the presentation; and
re-assembling the presentation to create a modified presentation using the new location of the one of the plurality of thumbnails.

23. A method of using a remote presentation system in a distributed environment, comprising:
logging onto a server;
initializing a graphical user interface using the server;
loading a presentation file onto the server;
selecting a presentation application using logic of the server;
opening the presentation file using the selected presentation application into a presentation;
capturing the presentation as a plurality of thumbnails;
forwarding the plurality of thumbnails to the graphical user interface located on the client;
selecting a one of the plurality of thumbnails;
modifying a thumbnail property of the one of the plurality of thumbnails creating a modified thumbnail; and
re-assembling the presentation to create a modified presentation using the modified thumbnail.

24. An apparatus for using a remote presentation system in a distributed environment, comprising:
means for logging onto a server;
means for initializing a graphical user interface using the server;
means for loading a presentation file onto the server;
means for selecting a presentation application using logic of the server;
means for opening the presentation file using the selected presentation application into a presentation;
means for capturing the presentation as a plurality of thumbnails; and
means for forwarding the plurality of thumbnails to the graphical user interface located on the client.

25. An apparatus for using a remote presentation system in a distributed environment, comprising:
means for logging onto a server;
means for initializing a graphical user interface using the server;
means for loading a presentation file onto the server;
means for selecting a presentation application using logic of the server;
means for opening the presentation file using the selected presentation application into a presentation;
means for capturing the presentation as a plurality of thumbnails;
means for forwarding the plurality of thumbnails to the graphical user interface located on the client;
means for selecting a one of the plurality of thumbnails;
means for moving the one of the plurality of thumbnails to a new location within the presentation; and
means for re-assembling the presentation to create a modified presentation using the new location of the one of the plurality of thumbnails.

26. An apparatus for using a remote presentation system in a distributed environment, comprising:
means for logging onto a server;
means for initializing a graphical user interface using the server;
means for loading a presentation file onto the server;
means for selecting a presentation application using logic of the server;
means for opening the presentation file using the selected presentation application into a presentation;
means for capturing the presentation as a plurality of thumbnails;
means for forwarding the plurality of thumbnails to the graphical user interface located on the client;
means for selecting a one of the plurality of thumbnails;
means for modifying a thumbnail property of the one of the plurality of thumbnails creating a modified thumbnail; and
means for re-assembling the presentation to create a modified presentation using the modified thumbnail.
